(19) United States
(12) Patent Application Publication
(10) Pub. No.: US 2006/0132676 A1
(43) Pub. Date: Jun. 22, 2006

(54) Polarizer and liquid crystal panel

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/292,516

(22) Filed: Dec. 2, 2005

(30) Foreign Application Priority Data
Dec. 3, 2004 (TW) 93137384

(51) Int. Cl. G02F 1/1335

(52) U.S. Cl. 349/96

(57) ABSTRACT

A polarizer (10) for a liquid crystal panel includes a first and second transparent filmss (11, 12) facing each other, and a birefringence crystal layer (13) sandwiched by the first and second transparent films. A thickness of the birefringence crystal layer is calculated according to the formula expresses as:
[(k+½)×λ]÷(nₒ−nₑ);

where k is a natural numbers, λ is a wavelength of light passing through the birefringence crystal layer beams, nₒno is an ordinary refractive index of the birefringence crystal layer, and nₑne is an extraordinary refractive indexes of the birefringence crystal layer. Unpolarized light beams emitted by a light source are substantially all passed through the polarizer. Therefore, the polarizer can provide highly efficient utilization of light beams.

### BACKGROUND

1. Field of the Invention

The present invention relates to a polarizers, and especially a polarizer used by a liquid crystal panel.

2. General Background

Most portable electronic devices such as laptop and notebook computers, mobile phones and game devices have viewing screens unlike the cathode-ray-tube (CRT) monitors of conventional desktop computers. Users generally expect the viewing screens to provide performance equal to that of CRT monitors. To meet this demand, computer manufacturers have sought to build flat panel displays (FPDs) offering superior resolution, color and contrast, while at the same time requiring minimal power consumption. LCDs are one type of FPD which satisfy these expectations. However, the liquid crystals of an LCD are not self-luminescent. Rather, the LCD generally needs a surface emitting device such as a backlight module which offers sufficient luminance (brightness) in a wide variety of ambient light environments.

Referring to FIG. 3, a conventional LCD 200 includes a backlight system 240, a liquid crystal cell (not labeled), and a pair of polarizers 211, 221 having optical axes perpendicular to each other. The liquid crystal cell includes a thin film transistor (TFT) substrate 220, a color filter substrate 210, and a liquid crystal layer 230 disposed between the substrates 210, 220. The backlight system 240 includes a light guide plate 241, a light source 242, and a light source reflector 243. Light beams emitted from the light source 242 enters the light guide plate 241 and emits uniformly from a top surface thereof.

In use particular, unpolarized light beams emitted by the light source 242 enter the light guide plate 241 and are transmitted to the polarizer 221. The polarizer 221 absorbs a first polarized component of the light beams, and transmits a second orthogonally polarized component of the light beams. The second orthogonally polarized component is transmitted to the liquid crystal cell. Thus, approximately 50% of the light beams emitted by the backlight system 240 are lost before reaching the liquid crystal cell. The second orthogonally polarized component passes through the TFT substrate 220, the liquid crystal layer 230, and the color filter substrate 210 in turn, with the result that generally no more than 20% of the light beams emitted by the backlight system 240 are is used. That is, the efficiency of use of the light source 242 is lower.

What is needed, therefore, is a liquid crystal panel with highly efficient utilization of light beams.

### SUMMARY

A polarizer includes a first and second transparent films facing each other, and a birefringence crystal layer sandwiched by the first and second transparent films. A thickness of the birefringence crystal layer expressesis calculated asas according to the following formula:
[(k+½)×λ]÷(nₒ−nₑ);
wWhere k is a natural numbers, λ is a wavelength of light beams, nₒ is an ordinary refractive index of the birefringence crystal layer, and nₑ is an extraordinary refractive indexes of the birefringence crystal layer.

An exemplary liquid crystal panel includes two of the the first and second above-described polarizers designated as a first polarizer and a second polarizer facing each other, and a liquid crystal cell sandwicheding by between the first and second polarizers.

In the liquid crystal panel, unpolarized light beams emitted by a light source are passed through the second polarizer and are emitted from the second polarizer parallel to a transmitting axis of the birefringence crystal layer, and The light beams then pass through the liquid crystal cell and the first polarizer, finally, and then emit from the first polarizer parallel to the transmitting axis of the birefringence crystal layer. Therefore, the liquid crystal panel can provides highly efficient utilization of light beams.

Other advantages and novel features of embodiments of the present invention will become more apparent from the following detailed description when taken in conjunction with the accompanying drawings;, in which:

### BRIEF DESCRIPTION OF THE DRAWINGS

FIG. 1 is a schematic, isometric view of a polarizer of a preferred embodiment of the present invention;

FIG. 2 is an schematic, exploded, isometric side view of an exemplary liquid crystal panel employinged the polarizer of FIG. 1; and

FIG. 3 is a schematic, exploded, isometric side view of a conventional LCD, showing essential optical paths thereof.

### DETAILED DESCRIPTION OF PREFERRED EMBODIMENTS

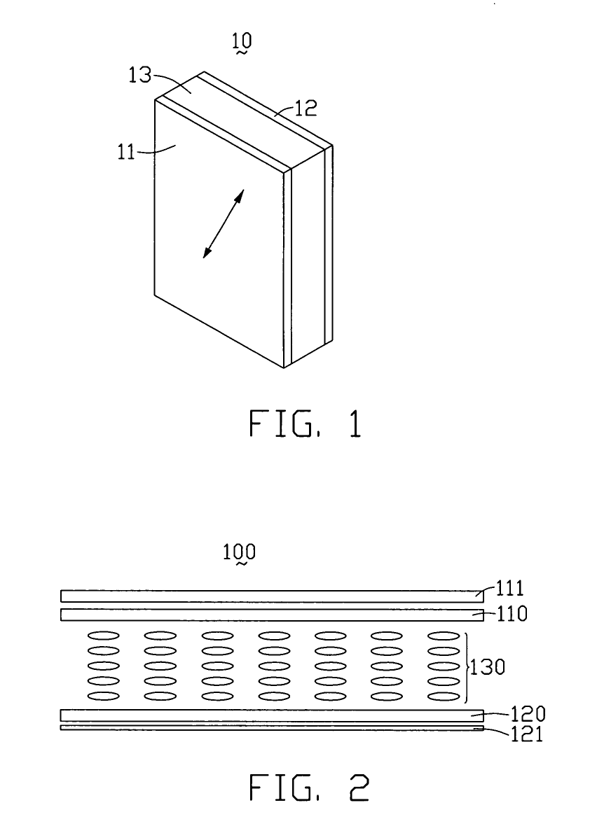

Referring to FIG. 1, a schematic, isometric view of a polarizer of a preferred embodiment of the present invention is shown. The polarizer 10 includes a first and second transparent films 11, 12 facing each other, and a birefringence crystal layer 13 sandwiched by between the first and second transparent films 11, 12.

The first and second transparent films 11, 12 are made from transparent material that unpolarized light beams can transmit through. The birefringence crystal layer 13 is made from a transparent material, which is selected from the group consisting of Al₂O₃, SiO₂, ITO (Indium-Tin Oxide), YVO₄, and Ccalcite.

Unpolarized light beams emitted by a light source (not shown) includess a first polarized component parallel to a transmitting axis of the birefringence crystal layer 13, and a second polarized component perpendicular to the transmitting axis. When the unpolarized light beams areis transmitteds to the birefringence crystal layer 13, the first polarized component is passesd through the birefringence crystal layer 13 and emits from the birefringence crystal layer 13 still parallel to the transmitting axis, and the second polarized component is passesd through the birefringence crystal layer 13 and is adjusted to also emits from the birefringence crystal layer 13 no more perpendicularparallel to the transmitting axis.

When Tthe second polarized component entersed the birefringence crystal layer 13, it is divided into ordinary light beams and extraordinary light beams. When a phase difference between the ordinary light beams and the extraordinary light beams is (2k+1)×π, wherein k=0, 1, 2, 3 . . . , the ordinary light beams and the extraordinary light beams composeform a polarized light beams whicith itshaving a polarized direction converted 90°. tThereby, the second polarized component emits from the birefringence crystal layer 13 parallel to the transmitting axis. At the same time, aA thickness d of the birefringence crystal layer 13 is defined bycalculated according to the following formulas:

$$Δ = d ⨯ ( {n}_{o} - {n}_{e} ) ;$$

$$Γ = ( 2 π \div λ ) ⨯ Δ = ( 2 k + 1 ) ⨯ π ; ( k = 0 , 1 , 2 , 3 … )$$

$$Thus , \\ d = Γ \div [ ( 2 π \div λ ) ⨯ ( {n}_{o} - {n}_{e} ) ] = [ ( 2 k + 1 ) ⨯ π ] \div [ 2 ( 2 π \div λ ) ⨯ ( {n}_{o} - {n}_{e} ) ] \\ = [ ( k + 1 / 2 ) ⨯ λ ] \div ( {n}_{o} - {n}_{e} ) ; ( k = 0 , 1 , 2 , 3 … )$$

In the formulas, Δ is an optical path length difference between the ordinary lightbeams and the extraordinary light beams, Γ is a phase difference between the ordinary light beams and the extraordinary light beams, nₒ and nₑ are an ordinary refractive index and an extraordinary refractive index of the birefringence crystal layer 13 respectively, and λ is a wavelength of the light beams. And wWhen the birefringence crystal layer 13 is made from Ccalcite, nₒ and nₑ are respectively 1.658 and 1.486, and λ is 1500 microns, wherein the light beams having a wavelength in the range of from 350 to 2300 microns can transmit through the birefringence crystal layer 13. at Under thisese timeconditions, the thickness d of the birefringence crystal layer 13 is (8761k+4360.5) microns, wherein k=0, 1, 2, 3 . . . . And When the birefringence crystal layer 13 is made from YVO₄, the light beams having a wavelength in the range offrom 450 to 5000 microns can transmit through the birefringence crystal layer 13.

In use, unpolarized light beams emitted by the light source are passed throughstrikes the polarizer 10 and are is then transformed to emitted from the polarizer 10 parallel to the transmitting axis of the birefringence crystal layer 13. Therefore, the polarizer 10 can provideis highly efficient in the utilization of light beams.

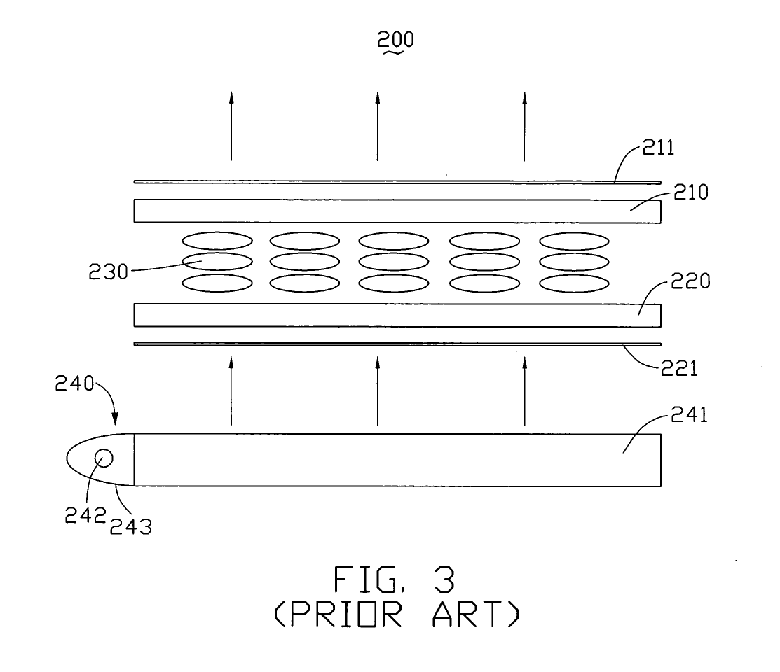

Referring to FIG. 2, an schematic, exploded, isometric side view of a liquid crystal panel according to one an exemplary embodiment of the present invention is shown. The liquid crystal panel 100 includes two ofthe above-described polarizers 10, which are designated as thea first and a second above-described polarizerss 111, 121 facing each other. The liquid crystal panel 100 andlso includes a liquid crystal cell (not labeled) sandwicheding by the first and second polarizers 111, 121. The first and second polarizers 111, 121 have a similar structure withsimilar to the polarizer 32. The liquid crystal cell includes a first and second substrates 110, 120 facing each other, and a liquid crystal layer 130 disposed between the first and second substrates 110, 120.

In operation of the liquid crystal panel 100, unpolarized light beams is emitted by a light source located beneath the liquid crystal panel 100. The light are passedstrikes through the second polarizer 121, and are is transformed within the second polarizer 121 to emitted from the second polarizer 121 parallel to the transmitting axis of the birefringence crystal layer of the second polarizer 121, and The light then passes through the liquid crystal cell and the first polarizer 111, and finally, emittings from the first polarizer 111 parallel to the transmitting axis of the birefringence crystal layer of the first polarizer 111. Therefore, the liquid crystal panel 100 can provideis highly efficient in the utilization of light beams.

It is to be understood, however, that even though numerous characteristics and advantages of the present embodiments have been set forth in the foregoing description, together with details of the structures and functions of the embodiments, the disclosure is illustrative only, and changes may be made in detail to the full extent indicated by the broad general meaning of the terms in which the appended claims are expressed.

I claim:

1. A liquid crystal panel, comprising:
a first polarizer and a second polarizer facing each other, each of the first and second polarizers each comprising a first and second transparent films, facing each other, and a birefringence crystal layer sandwiched by the first and second transparent films, a thickness of the birefringence crystal layer expressed asisbeing calculated according to the formula:
[(k+½)×λ]÷(nₒ−nₑ);
wherein k is a natural numbers, λ is a wavelength of light passing through the birefringence crystal layer beams, nₒ is an ordinary refractive index of the birefringence crystal layer, and nₑ is an extraordinary refractive indexes of the birefringence crystal layer; and
a liquid crystal cell sandwiched between the first and second polarizers.

2. The liquid crystal panel as claimed in claim 1, wherein the birefringence crystal layer is made from a transparent material.

3. The liquid crystal panel as claimed in claim 2, wherein the transparent material is selected from the group consisting of Al₂O₃, SiO₂, and ITO (Indium-Tin Oxide).

4. The liquid crystal panel as claimed in claim 2, wherein the birefringence crystal layer is made from Ccalcite, and λ is in the range offrom 350 to 2300 microns.

5. The liquid crystal panel as claimed in claim 2, wherein the birefringence crystal layer is made from YVO₄, and λ is in the range of from 450 to 5000 microns.

6. A polarizer comprising:
a first transparent film and a second transparent films facing each other;
a birefringence crystal layer sandwiched betweeny the first and second transparent films, a thickness of the birefringence crystal layer expressed asisbeing calculated according to the formula:
[(k+½)×λ]÷(nₒ−nₑ);
wherein k is a natural numbers, λ is a wavelength of light passing through the birefringence crystal layer beams, nₒ is an ordinary refractive index of the birefringence crystal layer, and nₑ is an extraordinary refractive indexes of the birefringence crystal layer.

7. The liquid crystal panel as claimed in claim 6, wherein the birefringence crystal layer is made from a transparent material.

8. The liquid crystal panel as claimed in claim 7, wherein the transparent material is selected from the group consisting of Al₂O₃, SiO₂, and ITO (Indium-Tin Oxide).

9. The liquid crystal panel as claimed in claim 7, wherein the birefringence crystal layer is made from Ccalcite, and λ is in the range of from 350 to 2300 microns.

10. The liquid crystal panel as claimed in claim 7, wherein the birefringence crystal layer is made from YVO₄, and λ is in the range of from 450 to 5000 microns.
